(19) United States
(12) Patent Application Publication
(10) Pub. No.: US 2015/0070438 A1
(43) Pub. Date: Mar. 12, 2015

(54) LIQUID EJECTION HEAD AND LIQUID EJECTION APPARATUS

(71) Applicant: CANON KABUSHIKI KAISHA, Tokyo (JP)

(72) Inventors: Kenji Yabe, Yokohama-shi (JP); Yasuhiko Osaki, Yokohama-shi (JP)

(21) Appl. No.: 14/480,441

(22) Filed: Sep. 8, 2014

(30) Foreign Application Priority Data
Sep. 10, 2013 (JP) 2013-187348

(51) Int. Cl. B41J 2/14

(52) U.S. Cl. CPC B41J 2/14072
USPC 347/50

(57) ABSTRACT

A liquid ejection head includes a first recording element substrate, a second recording element substrate, and an electric wiring substrate. The first and second recording element substrates each includes an energy generating element that generates energy for ejecting a liquid, and an electroconductive protective film that is disposed so as to cover at least the energy generating element. The electric wiring substrate includes wiring for supplying electric power to the first and second recording element substrates. The electroconductive protective film of the first recording element substrate and the electroconductive protective film of the second recording element substrate are electrically connected to each other through the electric wiring substrate.

### BACKGROUND OF THE INVENTION

1. Field of the Invention

The present invention relates to a liquid ejection head and a liquid ejection apparatus for ejecting a liquid.

2. Description of the Related Art

Some liquid ejection heads for ejecting a liquid, such as an ink, include a recording element substrate and an ejection orifice member. The recording element substrate includes a plurality of energy generating elements for generating thermal energy used to eject a liquid. The ejection orifice member has ejection orifices from which the liquid is ejected. Heat generating resistor layers, which generate heat when electrified, are used as the energy generating elements. The heat generating resistor layers generate heat for forming bubbles in the liquid, and the liquid is ejected from the ejection orifices due to pressure generated by the bubbles.

The energy generating elements are covered with an insulation film, and a protective film is formed on the insulating film. The protective film is made of an electroconductive material such as tantalum (Ta). The protective film serves to protect the energy generating elements from a so-called cavitation impact and from a chemical reaction that occurs in the liquid. Here, the term “cavitation impact” refers to an impact that occurs when bubbles, generated by the energy generating elements, burst.

There is a concern that, if the insulation film of the liquid ejection head has a defect, such a hole (pin hole), the energy generating elements and the protective film may be electrically connected to each other, so that the protective film and the liquid may cause an electrochemical reaction, leading to degradation of the protective film. When degradation of the protective film occurs, the thermal efficiency of energy transferred from the energy generating element to the liquid changes. Therefore, for example, it is necessary to check the electrical insulation between the energy generating elements and the protective film during the process of manufacturing the recording element substrate.

Japanese Patent Laid-Open No. 2000-280477 discloses an inkjet recording head including a protective film and a circuit for detecting whether or not en electric current flows through a protective film and a liquid (ink) in a flow path.

Such detection can be easily performed by connecting protective films in the same recording element substrate so as to be electrically connected to each other and by using a terminal provided in the substrate. On the other hand, when the protective films are electrically connected to each other in the recording element substrate, degradation of some of the protective films may affect all the protective films in the substrate.

Some liquid ejection heads, such as a full-line head having a length corresponding to the width of a recording medium, includes a plurality of recording element substrates. If the substrates described above, in each of which the protective films are electrically connected to each other, are used for a liquid ejection head of this type, the following problem may occur.

If the liquid ejection head is assembled by using a plurality of substrates including a substrate in which a protective film has a defect, the thermal efficiency of the protective film having a defect deviates from those of other substrates, and therefore the minimum energy required for ejecting a liquid varies. When the liquid ejection characteristics of some of the substrates vary as described above in a liquid ejection head having a plurality of substrates, such as a full-line head, the amount of ejected ink varies and therefore the density of recording becomes nonuniform.

The same problem may occur if a hole is formed in the protective films or the insulation films of some of the substrates during use of the liquid ejection head.

### SUMMARY OF THE INVENTION

The present invention provides a liquid ejection head that includes a plurality of recording element substrates and that is capable of suppressing occurrence of nonuniform recording due to degradation of protective films in some of the substrates.

A liquid ejection head includes a first recording element substrate, a second recording element substrate, and an electric wiring substrate. The first and second recording element substrates each includes an energy generating element that generates energy for ejecting a liquid, and an electroconductive protective film that is disposed so as to cover at least the energy generating element. The electric wiring substrate includes wiring for supplying electric power to the first and second recording element substrates. The electroconductive protective film of the first recording element substrate and the electroconductive protective film of the second recording element substrate are electrically connected to each other through the electric wiring substrate.

Further features of the present invention will become apparent from the following description of exemplary embodiments with reference to the attached drawings.

### BRIEF DESCRIPTION OF THE DRAWINGS

FIGS. 1A and 1B are schematic views illustrating electrical connection between a plurality of recording element substrates according to a first embodiment.

FIGS. 2A and 2B illustrate an inkjet recording head.

FIGS. 3A and 3B illustrate one of the recording element substrates.

FIG. 4 is a schematic cross-sectional view illustrating the layered structure of the recording element substrate.

FIG. 5 is a schematic view illustrating an electric wiring substrate.

FIG. 6 is a schematic view illustrating an inkjet recording apparatus.

FIGS. 7A to 7C are schematic sectional views for illustrating a problem to be solved by the present invention.

FIGS. 8A to 8C are schematic sectional views for illustrating another problem to be solved by the present invention.

FIGS. 9A and 9B are schematic views illustrating electrical connection between a plurality of recording element substrates according to a second embodiment.

FIGS. 10A and 10B are schematic views illustrating electrical connection between a plurality of recording element substrates according to a third embodiment.

### DESCRIPTION OF THE EMBODIMENTS

### Liquid Ejection Head

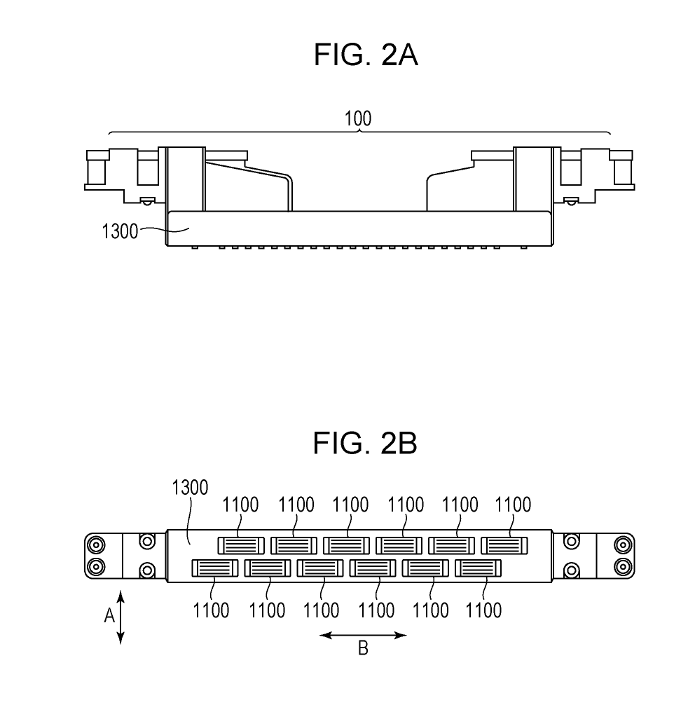

FIGS. 2A and 2B illustrate the structure of an inkjet recording head 100 (hereinafter, referred to as a “recording head”), which corresponds to a liquid ejection head according to the present invention. FIG. 2A is a side view of the recording head 100. FIG. 2B is a bottom view of the recording head 100, showing a surface from which an ink is ejected.

The recording head 100 according to the present embodiment is a full-line inkjet recording head, which can perform recording on a wide recording medium without scanning the recording medium. The recording head 100 includes a plurality of recording element substrates 1100 so as to cover the maximum width of a recording medium to be used.

### Recording Element Substrate

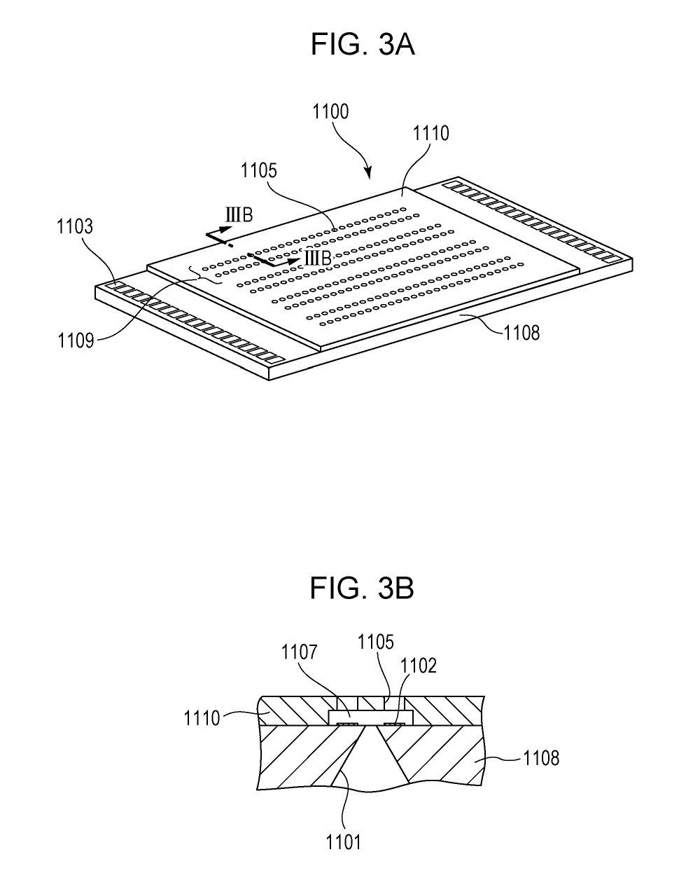

Referring to FIGS. 3A and 3B, the structure of one of the recording element substrates 1100 will be described. FIG. 3A is perspective view of the recording element substrate 1100. FIG. 3B is a sectional view taken along a line IIIB-IIIB of FIG. 3A.

The recording element substrate 1100 includes a substrate 1108 in which ink supply holes 1101 are formed. The substrate 1108 has a thickness of, for example, 0.5 to 1 mm. Each of the ink supply holes 1101 is a long-groove-shaped through-hole. On both sides of the ink supply hole 1101, heat application portions 1102 are arranged along a pair of rows in a staggered manner. Electrode terminals 1103 for supplying electric power are disposed at ends of the recording element substrate 1100. An ejection orifice member 1110 is disposed on the substrate 1108. In the ejection orifice member 1110, ejection orifices 1105, bubble-generating chambers 1107, and ink flow paths are formed so as to correspond to the heat application portions 1102 by photolithography. The ejection orifices 1105 are disposed so as to face the heat application portions 1102. An ink is supplied from the ink supply hole 1101, the heat application portions 1102 apply thermal energy to the ink to generate bubbles, and therefore the ink is ejected.

As illustrated in FIG. 3A, the recording element substrate 1100 has a plurality of ejection orifice rows 1109. In the present embodiment, four ink supply holes 1101 are formed so as to correspond to four sets of ejection orifice rows 1109. Ink having the same color may be supplied through the plurality of ink supply holes 1101 of the recording element substrate 1100. Alternatively, inks of four colors, such as cyan, magenta, yellow, and black may be supplied through the four ink supply holes 1101.

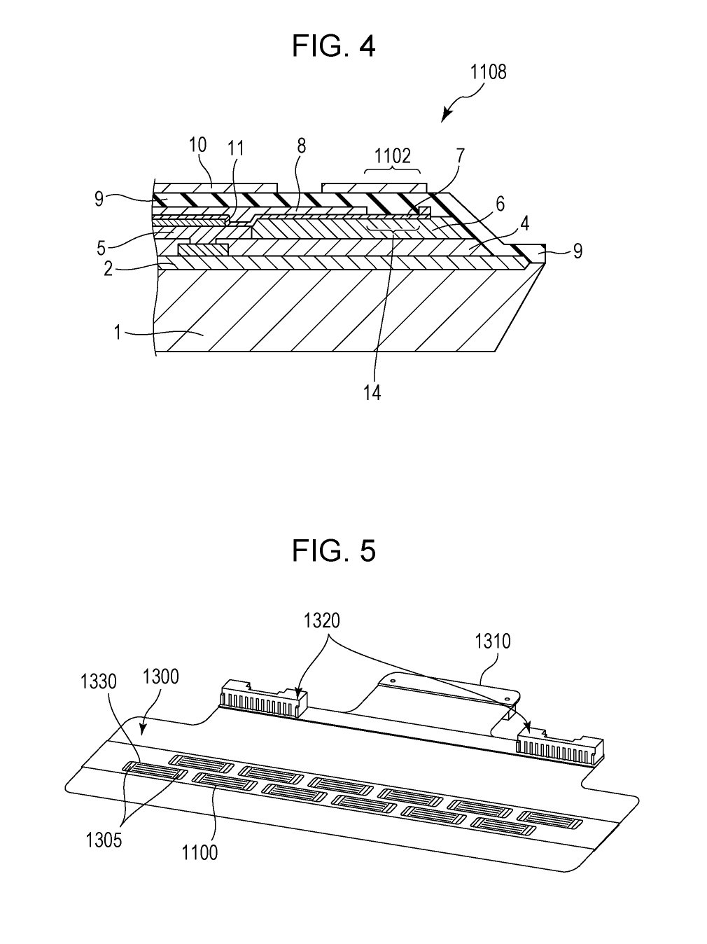

Referring to FIG. 4, the layer structure of the recording element substrate 1100 will be described. The ejection orifice member 1110 is not illustrated in FIG. 4.

A Si substrate or a Si substrate having an embedded drive IC is used as a substrate 1. A heat accumulating layer 2, which is formed by thermal oxidation or the like, is disposed on the substrate 1. A heat accumulating layer 4, which is formed by CVD or the like, is disposed on the heat accumulating layer 2. Common bus wiring 5 is formed on the heat accumulating layer 4 by forming a wiring layer by sputtering, forming a pattern by photolithography, and etching the wiring layer by reactive ion etching. The common bus wiring 5 is made of Al, Cu, Al—Si, Al—Cu, or the like. An insulation film 6, which is made from SiO2 or the like by sputtering and plasma CVD, is disposed on the common bus wiring 5. A through-hole portion 11 is formed in the insulation film 6 by forming a through-hole pattern by photolithography or the like and etching the insulation film 6 by dry etching or the like.

A heat generating resistor layer 7, which is made of TaN, TaSiN, or the like, and individual electrode wiring 8, which is made of Al, Cu, Al—Cu, Al—Si or the like, are formed on the insulation film 6 by reactive sputtering. A pattern is formed by photolithography on the heat generating resistor layer 7 and the individual electrode wiring 8, and the layer 7 and the wiring 8 are continuously etched by reactive ion etching or the like. Moreover, a part of the individual electrode wiring 8 is removed by photolithography and wet etching. This part of the heat generating resistor layer 7, which is exposed from the individual electrode wiring 8, serves as an electrothermal transducer 14, which corresponds to an energy generating element. The heat generating resistor layer 7 and the individual electrode wiring 8 may be stacked in the opposite order.

An insulation film 9, which is made of SiN, is formed on the individual electrode wiring 8 by plasma CVD. An anti-cavitation film 10 (hereinafter, referred to as a “protective film”), which corresponds to an electroconductive protective film, is formed on the insulation film 9 by sputtering. The protective film 10 is disposed at least in an upper part of the substrate 1108 corresponding to the electrothermal transducer 14. A part of the protective film 10 that is positioned in the upper part corresponding to the electrothermal transducer 14 and that contacts ink functions as the heat application portion 1102. In the present embodiment, a tantalum (Ta) film is used as the protective film 10. The materials of the recording element substrate 1100 described above are examples, and the materials are not limited to the aforementioned substances. For example, iridium (Ir) can be used instead of tantalum, or both of tantalum and iridium may be used.

### Electric Wiring Substrate

FIG. 5 illustrates the structure of an electric wiring substrate 1300. The recording element substrates 1100 are also shown in FIG. 5.

The electric wiring substrate 1300, in which a plurality of wires are formed, electrically connects the recording element substrates 1100 to the body of an inkjet recording apparatus 3000 through the wires. Electrical signals, electric power, and the like, which are supplied from the outside and used to eject ink, are supplied to the recording element substrates 1100 through the electric wiring substrate 1300. In the present embodiment, the electric wiring substrate 1300 is a flexible wiring substrate in which wiring is formed on a resin film.

The electric wiring substrate 1300 has a plurality of openings 1330, in which the recording element substrates 1100 are placed. The electric wiring substrate 1300 includes electrode terminals (not shown), an electric signal connector 1310, and a power connector 1320. The electrode terminals are provided so as to correspond to the electrode terminals 1103 of the recording element substrate 1100. The electric signal connector 1310 is disposed at an end of wiring and receives electric signals from the body of the inkjet recording apparatus 3000. The power connectors 1320 receive electric power.

The electric wiring substrate 1300 and the recording element substrates 1100 are electrically connected to each other by, for example, connecting the electrode terminals 1103 of the recording element substrates 1100 to the electrode terminals of the electric wiring substrate 1300 by wire bonding using a gold wire. The electrode terminals 1103 of the recording element substrate 1100, the electrode terminals of the electric wiring substrate 1300, and the bonding wires are covered by sealants 1305, so that these terminals and wires are protected from corrosion due to ink and from an external shock.

### Inkjet Recording Apparatus

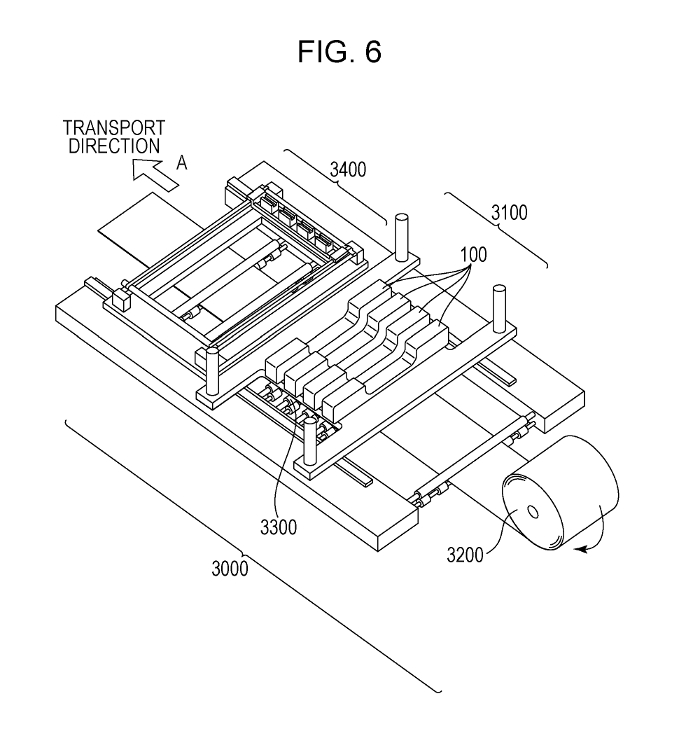

Referring to FIG. 6, the structure of the inkjet recording apparatus 3000, in which the inkjet the recording heads 100 are mounted, will be described.

The recording apparatus 3000 is a line printer that performs printing on a recording sheet, which corresponds to a recording medium, by using the recording heads 100, each of which is a long full-line head, while continuously transporting the recording sheet in a transport direction (direction A). The recording apparatus 3000 includes a holder, a transport mechanism 3300, and a recording unit 3100. The holder holds a recording sheet 3200, which is, for example, a rolled continuous paper sheet. The transport mechanism 3300 transports the recording sheet 3200 at a predetermined speed in the direction A. The recording unit 3100 performs recording on the recording sheet 3200 by using the recording heads 100. The recording sheet 3200 is not limited to a continuous rolled sheet, and may be a cut sheet.

The recording unit 3100 includes the plurality of recording heads 100, which correspond to different ink colors. In the present embodiment, four recording heads 100 are provided so as to correspond to cyan, magenta, yellow, and black. However, there is no limitation on the number of ink colors.

### Problem Related to Defect of Recording Element Substrate

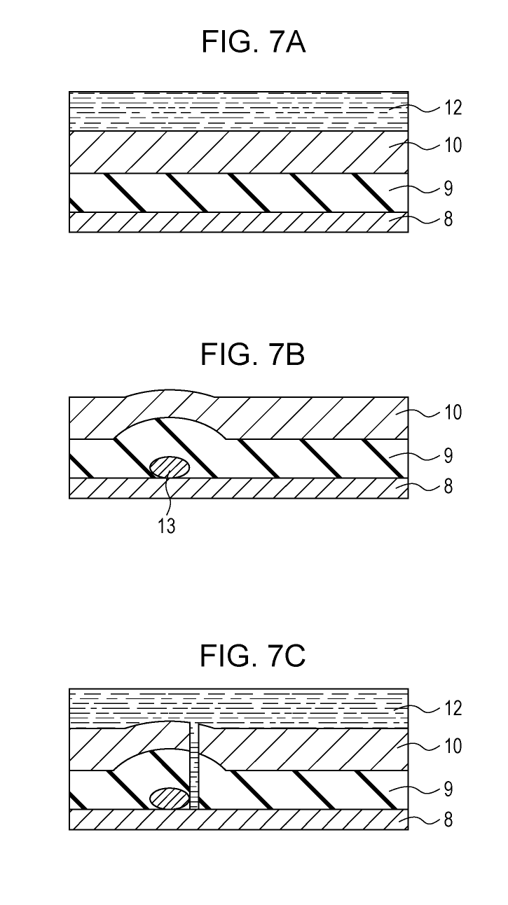

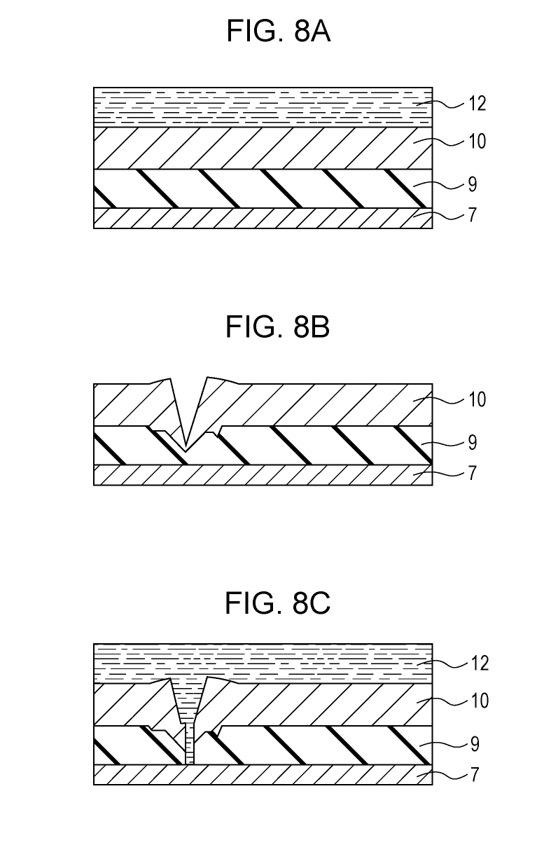

Referring to FIGS. 7A to 8C, which are partial sectional views of the recording element substrate 1100, a problem that arises when a defect occurs in the insulation film 9 or the protective film 10 of the recording element substrate 1100 will be described.

FIGS. 7A and 8A illustrate a recording element substrate 1100 that does not have a defect. The numeral 12 denotes ink. As illustrated in FIG. 7B, when the films of the recording element substrate 1100 are being formed, a foreign matter 13 may adhere to one of the films. If the foreign matter 13 adheres to the individual electrode wiring 8, a bump is generated due to the foreign matter 13, and therefore the thicknesses of parts of the insulation film 9 and the protective film 10 formed on the foreign matter 13 may become smaller than appropriate thicknesses. If this occurs, when the recording head 100 is filled with ink and the electrothermal transducer 14 is driven, a thermal stress is applied to the thin parts of the films and a crack may be generated in the thin parts. As a result, as shown in FIG. 7C, the ink 12 passes through the protective film 10 to the individual electrode wiring 8, and therefore a short circuit may occur between the protective film 10 and the individual electrode wiring 8. Then, the surface of the protective film 10, including Ta, electrically serves as an anode, and an electrochemical reaction between the protective film 10 and the ink occurs. As a result, the surface or the inside of the protective film 10 may become oxidized (also referred to as “anodized”) in a short time.

As illustrated in FIG. 8B, a defect in the protective film 10 may occur when the recording head 100 is being manufactured or during use of the recording head 100. If a defect occurs in the protective film 10, for protecting the heat generating resistor layer 7, and the defect extends to the insulation film 9, the ink 12 reaches the heat generating resistor layer 7 and causes a short circuit between the protective film 10 and the heat generating resistor layer 7. Then, in the same manner as described above, the surface of the protective film 10, including Ta, electrically serves as an anode, and an electrochemical reaction between the protective film 10 and the ink occurs, so that the surface or the inside of the protective film 10 may become oxidized in a short time.

If anodization of the protective film 10 occurs as described above, the crystalline state of the protective film 10 is changed and the thermal characteristics of the protective film 10 are changed. Because the protective film 10 is disposed on the electrothermal transducer 14, the minimum energy required for ejecting ink may be changed due to the change in the thermal characteristics of the protective film 10.

When ink is in contact with the surface of the protective film 10, anodization of the protective film 10 propagates to parts of the protective film 10 that are electrically connected to each other. For example, if an electrothermal transducer 14 of a recording element substrate 1100 has a defect, anodization occurs in a part of the protective film 10 located on the electrothermal transducer 14. Then, anodization propagates to a part of another protective film 10 that is electrically connected to the anodized protective film 10, the part being in contact with the ink. If the all of the protective films 10 in the recording element substrate 1100 are electrically connected to each other, anodization occurs almost uniformly in the recording element substrate 1100.

As described above, when the protective film 10 becomes anodized, the minimum energy required for ejection changes, and therefore the amount of ink in an ejected ink droplet and the ejection speed may be affected by the change. In particular, the recording head 100 according to the present embodiment includes a plurality of recording element substrates 1100. In this case, recording performed by a part of the recording head 100 corresponding to the anodized recording element substrate 1100 becomes nonuniform.

In the example described above, a Ta film is used as the protective film 10. However, a protective film 10 that can be used in the present embodiment is not limited to a Ta film, as long as oxidation occurs in the film when a voltage is applied to the film.

### First Embodiment

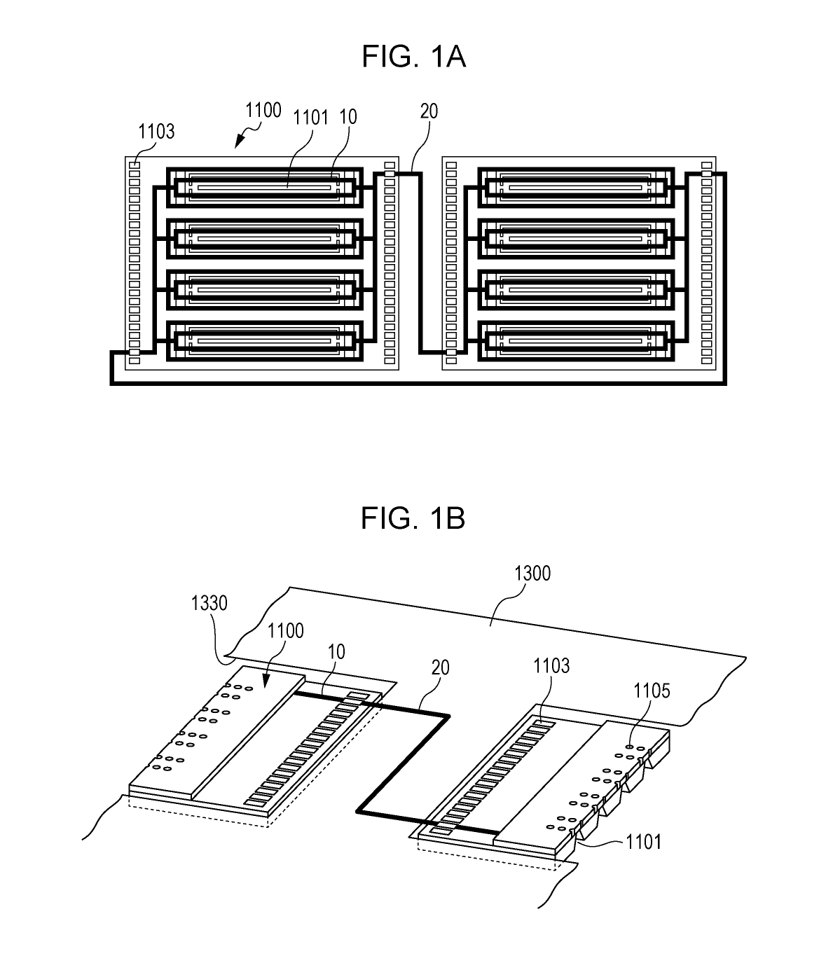

Referring to FIGS. 1A and 1B, a liquid ejection head according to a first embodiment of the present invention will be described. FIG. 1A is a partial bottom view of a recording head 100, and FIG. 1B is a partial perspective view of the recording head 100. In FIG. 1A, an electric wiring substrate 1300, an ejection orifice member 1110, and the like are not illustrated, in order to show the positions of wiring 20 and protective films 10.

A plurality of supply holes 1101 are formed in each of recording element substrates 1100, and the protective films 10 are formed so as to correspond to the supply holes 1101. In FIGS. 1A and 1B, four supply holes and four sets of protective films are formed in each of the recording element substrates 1100, and the four sets of protective films in each of the recording element substrates are electrically connected to each other.

In the first embodiment, the protective films 10 formed in the plurality of recording element substrates 1100 are electrically connected to each other. Thus, when anodization of the protective film 10 due to a defect occurs in some of the plurality of recording element substrates 1100 as described above, it is possible to immediately cause anodization of the protective films 10 of other recording element substrates 1100. Because the protective films 10 become anodized, the thermal characteristics of the protective film 10 are changed. However, the effect of anodization on ejection of ink is small. Moreover, because other recording element substrates 1100 become also anodized, as the entirety of the recording head 100, the thermal characteristics of the protective films 10 of the recording element substrates 1100 can be made uniform. Accordingly, occurrence of nonuniformity in the thermal characteristics the protective films 10 of the plurality of recording element substrates 1100 can be suppressed, and therefore the probability of occurrence of nonuniformity in recording can be reduced.

In each of the recording element substrates 1100, the protective films 10 are disposed in upper parts thereof corresponding to at least electrothermal transducers 14. As illustrated in FIG. 1A, in the recording element substrate 1100, the protective films 10 are electrically connected to each other. The protective films 10 in the recording element substrate 1100 may be connected to each other through conductive layers other than the protective films 10.

In order to electrically connect the protective films 10 of adjacent recording element substrates 1100 to each other, the protective films 10 are connected to electrode terminals 1103 in each of the recording element substrates 1100. The electrode terminals 1103 are electrically connected to the electric wiring substrate 1300 by wire bonding or the like. The electrode terminals 1103 of adjacent recording element substrates 1100 are electrically connected to each other through the wiring 20 in the electric wiring substrate 1300. Thus, the protective films 10 of the plurality of recording element substrates 1100 are electrically connected to each other.

It is not necessary that the wiring 20 in the electric wiring substrate 1300 connect adjacent recording element substrates 1100 to each other. However, the protective films 10 of all of the electric wiring substrates 1300 of the recording head 100 may be electrically connected to each other.

The recording head 100, which includes the recording element substrates 1100 having the structure described above, was filled with ink, and recording corresponding to a million dots per one ejection orifice 1105 was performed by using the inkjet recording apparatus 3000. As are result, it was confirmed that the protective films 10 of all of the recording element substrates 1100 of the recording head 100 were anodized. With the recording head 100 of the first embodiment, nonuniformity in recording was not found.

As described above, according to the first embodiment, reduction in the recording quality of the recording head 100 can be suppressed and the reliability of the product can be increased. Moreover, the yield in manufacturing the recording head 100 can be increased, because a recording element substrate 1100 including a protective film 10 that is likely to be anodized can be used.

The protective film 10 may be anodized, when manufacturing a recording head 100, by applying a voltage to the heat generating resistor layer 7 in a state in which the recording head 100 is filled with ink. By doing so, if the recording head 100 includes a recording element substrate 1100 in which anodization is likely to occur during the manufacturing process, anodization occurs in the protective films 10 of the plurality of recording element substrates 1100 included in the recording head 100. On the other hand, in a recording head 100 that does not include a recording element substrate 1100 in which anodization is likely to occur, anodization does not occur. Subsequently, driving conditions to be input are measured, and data of optimal driving ejection energy is stored in an EEPROM or the like. By driving the recording head 100, which is mounted in a recording apparatus, with the optimal driving ejection energy, uniform printing quality can be maintained irrespective of the presence or absence of anodization.

### Second Embodiment

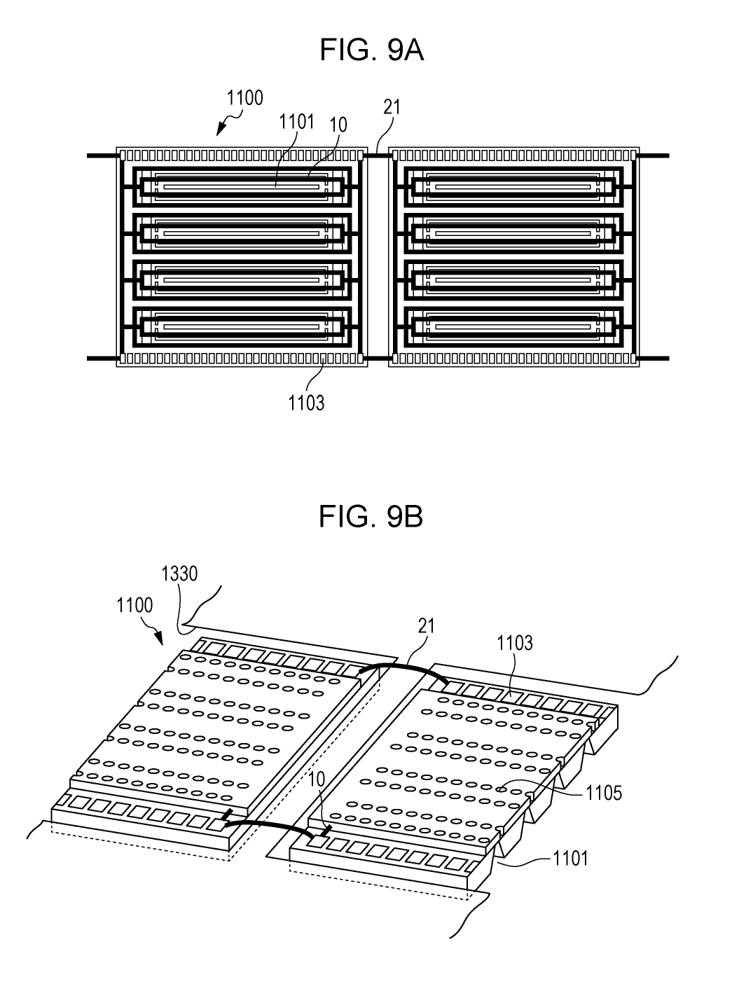

Referring to FIGS. 9A and 9B, a liquid ejection head according to a second embodiment of the present invention will be described. FIG. 9A is a partial bottom view of a recording head 100, and FIG. 9B is a partial perspective view of the recording head 100.

In the second embodiment, as in the first embodiment described above, protective films 10 of a plurality of recording element substrates 1100 are electrically connected to each other.

In each of the recording element substrates 1100, the protective films 10 are disposed in upper parts thereof corresponding to at least the electrothermal transducers 14. The second embodiment differs from the first embodiment in the pattern in which the protective films 10 are arranged. However, as in the first embodiment, in each recording element substrate 1100, the protective films 10 are electrically connected to each other.

In the second embodiment, in order to electrically connect the protective films 10 of adjacent recording element substrates 1100 to each other, electrode terminals 1103 of the recording element substrates 1100 are directly connected to each other through wires 21 by wire bonding or the like.

The second embodiment is particularly effective in a case where the electric wiring substrate 1300 does not have enough space for disposing wiring 20 or in a case where it is necessary to densely arrange a plurality of recording element substrates.

### Third Embodiment

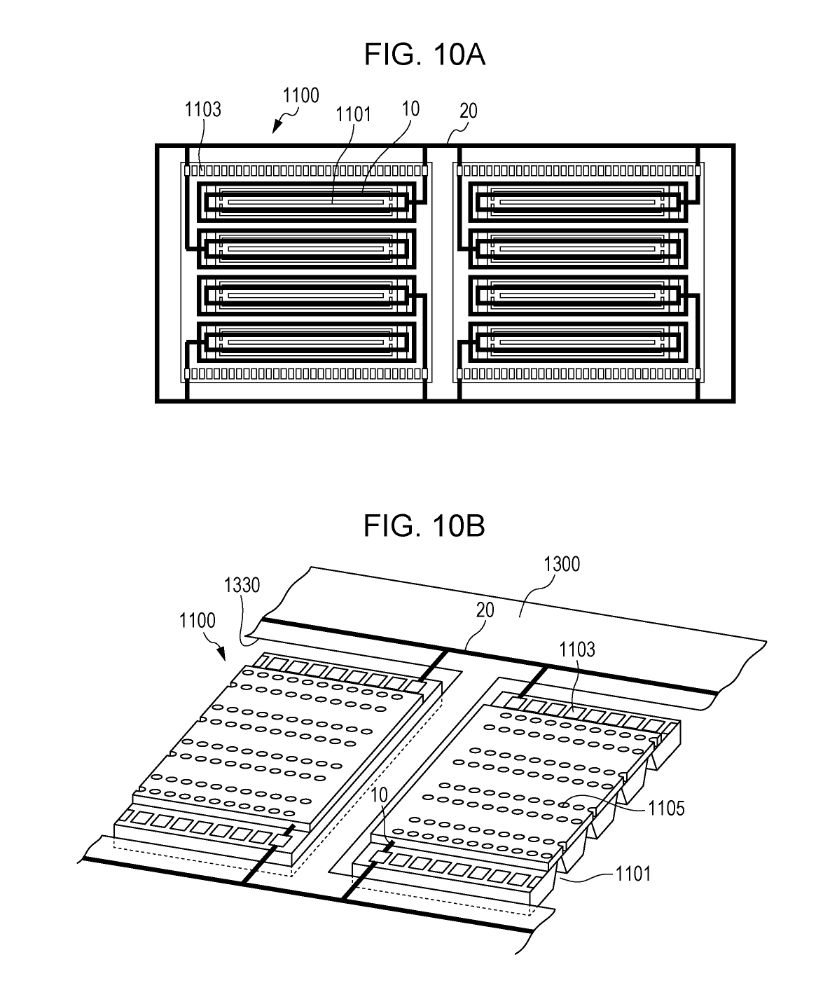

Referring to FIG. 10, a liquid ejection head according to a third embodiment of the present invention will be described. FIG. 10A is a partial bottom view of a recording head 100, and FIG. 10B is a partial perspective view of the recording head 100.

In the third embodiment, as in the first and second embodiments, protective films 10 of a plurality of recording element substrates 1100 are electrically connected to each other.

In each of the recording element substrates 1100, the protective films 10 are disposed in upper parts thereof corresponding to at least electrothermal transducers 14. In the third embodiment, as illustrated in FIG. 10A, the protective films 10 that are disposed around one ink supply hole 1101 are not electrically connected to each other in the recording element substrate 1100.

In the third embodiment, each of the protective films 10, which are not electrically connected to each other in the recording element substrate 1100, are connected to a corresponding one of electrode terminals 1103. The electrode terminals 1103 and an electric wiring substrate 1300 are electrically connected to each other by wire bonding or the like. The electrode terminals 1103 of adjacent recording element substrates 1100 are electrically connected to each other through wiring 20 in the electric wiring substrate 1300. Thus, the protective films 10 disposed in the plurality of recording element substrates 1100 are electrically connected to each other.

In the third embodiment, the wiring 20 and wires are disposed in a part of the recording element substrate 1100 located outside of outer peripheral parts of the substrate 1100 in which the electrode terminals 1103 are disposed, and the wiring 20 and the wires 21 are not disposed between adjacent recording element substrates 1100. In other words, the electrode terminal 1103 are connected to each other through the wiring 20, which is disposed outside of the recording element substrates 1100 in a direction crossing the direction in which the recording element substrates 1100 are arranged. The third embodiment is effective in a case where it is necessary to dispose adjacent recording element substrates 1100 more densely in the direction in which the recording element substrates 1100 are arranged.

A unit for detecting a condition of the protective film 10, that is, the presence/absence of anodization in the protective films 10, may be mounted in the recording head 100 or the recording apparatus 3000. Examples of the detection method include a method of periodically measuring the minimum energy required for ejection, a method of detecting a leakage current that flows when a voltage is applied to the electrothermal transducer 14, and a method of detecting the difference in the amount of light reflected by the protective film 10. On the basis of the detection result obtained by the unit for detecting anodization, a control unit, which is configured to control drive ejection energy to be generated by the electrothermal transducers 14, controls the drive ejection energy generated by the electrothermal transducers corresponding to the protective film 10 in which anodization has occurred. Thus, a change in the hue before and after starting anodization can be suppressed.

The recording head 100 in the embodiments described above is a full-line recording head. However, this is not a limitation, and the present invention can be applied to a recording head 100 of any type that includes a plurality of recording element substrates 1100.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-187348, filed Sep. 10, 2013, which is hereby incorporated by reference herein in its entirety.

What is claimed is:

1. A liquid ejection head comprising:
a plurality of recording element substrates each including
a member having an ejection orifice from which a liquid is ejected,
an energy generating element that generates energy for ejecting the liquid, and
a substrate including an electroconductive protective film that is disposed so as to cover at least the energy generating element,
wherein the electroconductive protective films of the plurality of recording element substrates are electrically connected to each other.

2. The liquid ejection head according to claim 1,
wherein the electroconductive protective films of the plurality of recording element substrates are electrically connected to each other through electrode terminals provided in the recording element substrates.

3. The liquid ejection head according to claim 1,
wherein each of the recording element substrates includes
a plurality of the energy generating elements, and
a plurality of the electroconductive protective films that cover the plurality of energy generating elements, and
wherein the electroconductive protective films are electrically connected to each other in each of the recording element substrates.

4. The liquid ejection head according to claim 1,
wherein each of the recording element substrates includes
a plurality of the energy generating elements, and
a plurality of the electroconductive protective films that cover the plurality of energy generating elements, and
wherein the plurality of electroconductive protective films are electrically connected to each other through a path outside of the recording element substrates.

5. The liquid ejection head according to claim 2, further comprising:
an electric wiring substrate including wiring that is electrically connected to the electrode terminals,
wherein the electroconductive protective films of the plurality of recording element substrates are electrically connected to each other through the wiring.

6. The liquid ejection head according to claim 2,
wherein the electroconductive protective films of the plurality of recording element substrates are electrically connected to each other by directly connecting the electrode terminals of the plurality of recording element substrates to each other by wire bonding.

7. The liquid ejection head according to claim 5,
wherein the wiring is disposed outside of the recording element substrates in a direction crossing a direction in which the plurality of recording element substrates are arranged, and the electrode terminals are electrically connected to each other through the wiring.

8. The liquid ejection head according to claim 1,
wherein the electroconductive protective film includes tantalum.

9. The liquid ejection head according to claim 1,
wherein each of the recording element substrates includes an insulation film disposed between the energy generating element and the electroconductive protective film.

10. A liquid ejection head comprising:
a first recording element substrate and a second recording element substrate each including
an energy generating element that generates energy for ejecting a liquid, and
an electroconductive protective film that is disposed so as to cover at least the energy generating element; and
an electric wiring substrate including wiring for supplying electric power to the first and second recording element substrates,
wherein the electroconductive protective film of the first recording element substrate and the electroconductive protective film of the second recording element substrate are electrically connected to each other through the electric wiring substrate.

11. The liquid ejection head according to claim 10,
wherein the first recording element substrate includes a plurality of sets of protective films, and the plurality of sets of protective films are electrically connected to each other.

12. The liquid ejection head according to claim 11,
wherein the first recording element substrate has a plurality of supply holes, and the plurality of sets of protective films are provided so as to correspond to the plurality of supply holes.

13. The liquid ejection head according to claim 10,
wherein the first and second recording element substrates each include an electrode terminal, and
wherein the electroconductive protective film of the first recording element substrate and the electroconductive protective film of the second recording element substrate are electrically connected to each other through the electrode terminals.

14. The liquid ejection head according to claim 10,
wherein the protective film of each of the first and second recording element substrates includes tantalum.

15. A liquid ejection apparatus comprising:
a first recording element substrate and a second recording element substrate each including
an energy generating element that generates energy for ejecting a liquid, and
an electroconductive protective film that is disposed so as to cover at least the energy generating element;
an electric wiring substrate including wiring for supplying electric power to the first and second recording element substrates; and
a control unit that controls energy generated by the energy generating element on the basis of a condition of the electroconductive protective film,
wherein the electroconductive protective film of the first recording element substrate and the electroconductive protective film of the second recording element substrate are electrically connected to each other through the electric wiring substrate.

16. The liquid ejection apparatus according to claim 15,
wherein the protective film of each of the first and second recording element substrates includes tantalum.

17. The liquid ejection apparatus according to claim 15,
wherein the first recording element substrate includes a plurality of sets of protective films, and the plurality of sets of protective films are electrically connected to each other.

18. The liquid ejection apparatus according to claim 15,
wherein the first and second recording element substrates each include an electrode terminal, and
wherein the electroconductive protective film of the first recording element substrate and the electroconductive protective film of the second recording element substrate are electrically connected to each other through the electrode terminals.
